(19) United States
(12) Patent Application Publication
(10) Pub. No.: US 2002/0116539 A1
(43) Pub. Date: Aug. 22, 2002

(54) Method and apparatus for displaying information on a large scale display

(76) Inventors: Krzysztof Bryczkowski, Bridgewater, NJ (US); Paul Noble, Short Hills, NJ (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 10/026,204

(22) Filed: Dec. 21, 2001

Related U.S. Application Data
(60) Provisional application No. 60/257,411, filed on Dec. 21, 2000.

(51) Int. Cl. G06F 9/44

(52) U.S. Cl. 709/317

(57) ABSTRACT

A large scale display system comprises a plurality of computing devices. The computing devices may include a control computer, a display computer, a source computer, and a remote control computer. In operation, three software components, a source server, a user server and an interface manager, are employed by the control computer. In turn, software agents are deployed in a source computer and in a display computer. The interface manager allows an operator to remotely compose, display and monitor a collection of sources that are simultaneously displayed on the video wall. The display sources can be local to the control computer or as is often the case, reside on a remote source computer.

This application claims the benefit of U.S. Provisional Applications No. 60/257,411 filed on Dec. 21, 2000, which is herein incorporated by reference.

The present invention relates to an apparatus and concomitant method for displaying information on a large scale display (LSD). More specifically, the present invention brings together both the visual and audio output and/or data from many applications on either intranet, extranet and internet network for integration, optional manipulation and orderly display on a large scale display.

### BACKGROUND OF THE DISCLOSURE

An enormous array of different information is readily available today and is often provided in real time. Many businesses, educational and governmental institutions have large gathering areas where various types of information can be provided via a large scale display or video wall. Examples may include the display of financial information above a trading floor, the display of a lecture conducted off site, but is being displayed locally to a student body and the display of troop deployments in a command and control facility.

Additionally, it is often desirable to control the video wall remotely. Namely, the human controller, and for that matter the data itself, are often not physically located in proximity to the video wall. In other words, the video wall is coupled to a network and must be controlled remotely. The ability to control, display and monitor a diverse array of information on a large scale display remotely provides numerous applications to businesses, educational and governmental institutions. Thus, it is important to provide a robust and flexible set of features or functions in the control, display and monitoring of information on a large scale display.

Therefore, a need exists for a robust and flexible method that provides for the control, display and monitoring of information on a large scale display.

### SUMMARY OF THE INVENTION

In one embodiment of the present invention, a large scale display system comprises a plurality of computing devices. The computing devices may include a control computer, a display computer, a source computer, and a remote control computer. The number of computing devices that are deployed is a function of the requirement of a particular application. However, at minimum, a large scale display system comprises a control computer, a display computer and a video display.

In operation, three software components, a source server, a user server and an interface manager, are employed by the control computer. In turn, software agents are deployed in a source computer and in a display computer. The interface manager allows an operator to remotely compose, display and monitor a collection of sources that are simultaneously displayed on the video wall. The display sources can be local to the control computer or as is often the case, reside on a remote source computer.

In another alternate embodiment, an KVM (keyboard, monitor, mouse) system is disclosed. In essence, the KVM system shares a similar architecture with the large scale display system. A unique aspect is the ability of the KVM system to allow a display computer to gain access to a source on a remote source computer without the need for addition wirings. Namely, the remote access functions of the KVM system are implemented via software.

### BRIEF DESCRIPTION OF THE DRAWINGS

The teachings of the present invention can be readily understood by considering the following detailed description in conjunction with the accompanying drawings, in which:

FIG. 1 illustrates a system level diagram of a large scale display system of the present invention;

FIG. 2 illustrates a system level block diagram of a large scale display system of the present invention;

FIG. 3 illustrates a KVM (keyboard, monitor, mouse) system of the present invention;

FIG. 4 illustrates a first screen display as viewed by a controller of the large scale display system of the present invention;

FIG. 5 illustrates a second screen display as viewed by a controller of the large scale display system of the present invention;

FIG. 6 illustrates a third screen display as viewed by a controller of the large scale display system of the present invention;

FIG. 7 illustrates a fourth screen display as viewed by a controller of the large scale display system of the present invention; and

FIG. 8 illustrates a block diagram of a computing device from the large scale display system of the present invention as implemented using a general purpose computer.

To facilitate understanding, identical reference numerals have been used, where possible, to designate identical elements that are common to the figures.

### DETAILED DESCRIPTION

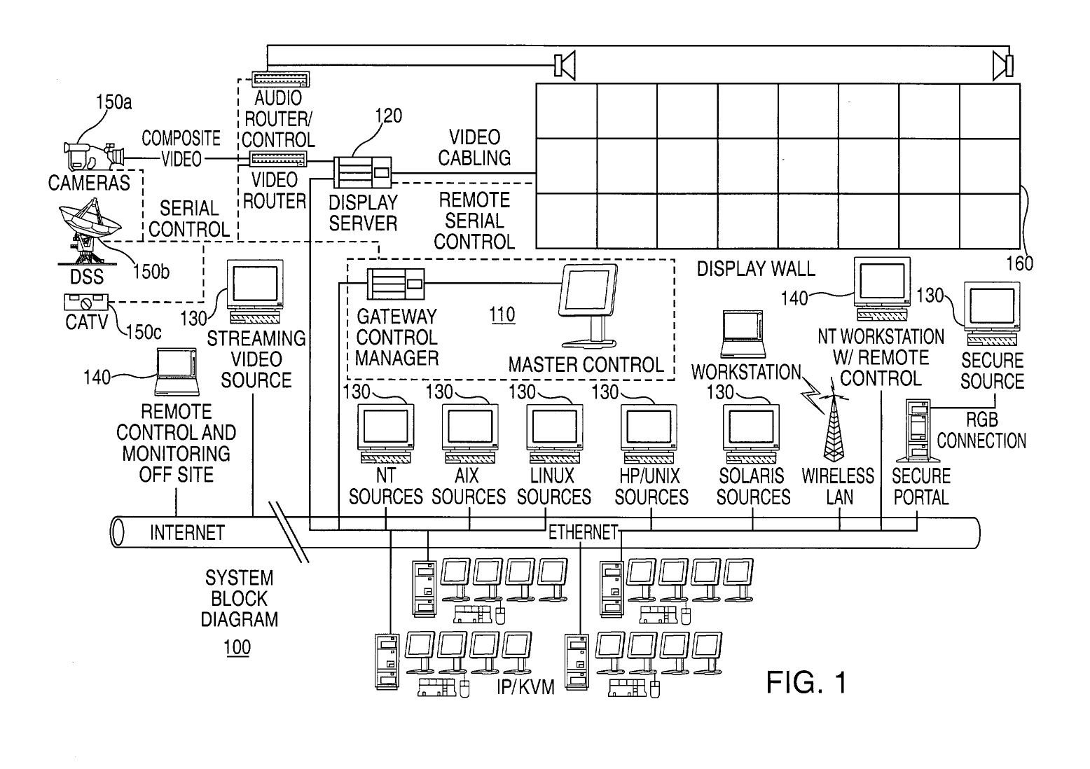

FIG. 1 illustrates a system level diagram of a large scale display system 100 of the present invention. The overall system 100 comprises four distinct types of computing devices: a control computer 110, a display computer 120, one or more source computers 130, and one or more remote control computer 140. The number of computing devices that are deployed in a system 100 depends on the need of a particular application. It should be noted that FIGS. 1-3 below when viewed with the discussion provided below, also serve as flowcharts for the present remote display control method.

The large scale display system 100 may also optionally employ display information from a plurality of analog or digital sources such as from a camera 150a, a satellite receiver 150b, a cable TV source 150c and the like. As illustrated by the system level diagram, the present invention is the integration, manipulation and orderly display of numerous date that are accessible from a network, e.g., via an Intranet or Internet. In other words, one aspect of the present invention is to bring together the visual/audio output and/or data from many managed objects to the final destination device, the large scale display (LSD) 160. Along these lines, the present invention can provide many levels of automation between managed objects.

The present invention can be implemented as a software package that allows for a simple, intuitive means to operate a data/video display system. The system can be a single display array with a single control station or can consist of many display walls with as many operator stations as needed. From the present invention, the operator(s) can also control a wide array of other devices and systems such as sound systems, lighting, and source devices such as DVD and VCR players. The present invention can command other computers through the use of proxy components to start and stop applications and call up information without the need for additional operators at these remote computers.

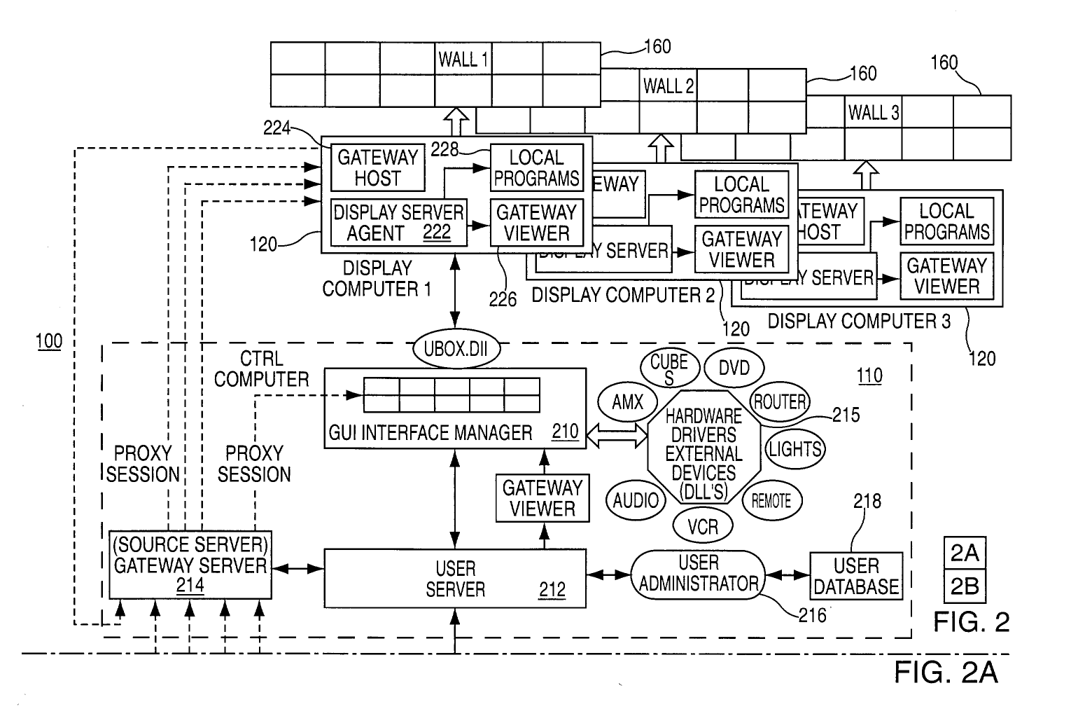

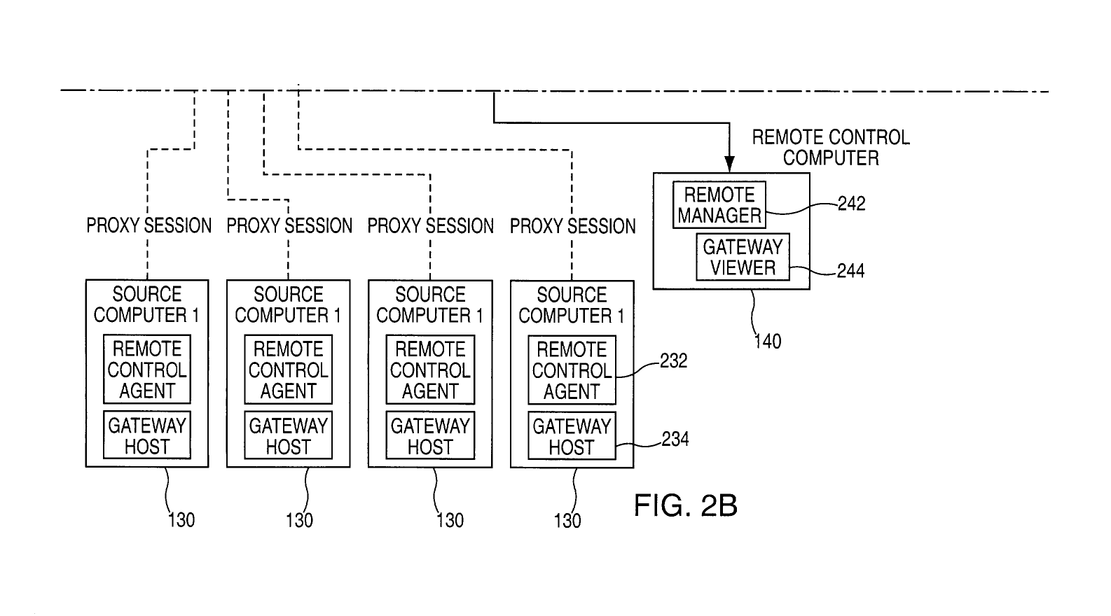

FIG. 2 illustrates the large scale display system 100 of the present invention in a block diagram format. First, the control computer 110 comprises a plurality of software components: 1) an interface manager 210, e.g., a graphic user interface (GUI) manager, 2) a user server module 212, 3) a gateway server or source server 214, 4) a user administrator module 216, and a user database 618.

The interface manager 210 is the heart of the large scale display system 100 in the sense that it provides system-wide integration of all its components. By implementing an intuitive and easy to use drag and drop graphical interface on top of the underlying Component Object Model (COM) architecture, this application gives non-technical users an ability to interact with the wide array of video and data input sources that the large scale display system is capable of handling. This feature rich application also provides the user with the capabilities of writing macros using a built-in unique Macro Language and later executing them, defining wall layout presets, creating virtual view screens, and live viewing and recording of computer source content through the ActivuPort. In addition to providing this powerful array of user tools, the interface manager 210 communicates with the “user server module” 212 using the Distributed Component Object Model (DCOM) protocol to provide a robust system security implementation. Thus, interface manager 210 provides for the control of all of the hardware in the system and the integration of the proxy components.

The user server module 212 is a COM architecture security implementation that creates a single point of user identity and action authentication. Every login request and action performed by a user is validated real-time using a username/password authentication scheme through the server's communication with the user database 218. In addition to this, the system communicates with the source or gateway server module 214 via the user server module 212. All source session requests are conveyed and authenticated through the user server module 212 and passed along to the source server module 214. Permissions are setup through the use of the user administrator 216 thus providing the system with a scalable and secure solution to multi-personnel controlled systems. In sum, user server module 212 serves to grant permission for each user action. All requests for proxy sessions pass thru the user server module.

The source server module 214 provides connectivity of source computers to the overall system. Through the use of low-level TCP/IP socket communication, the source server module can route multiple computer sources through itself to provide connectivity with the interface manager 210. The source server module 214 is administrated through the use of the Network Source Administrator which allows tasks such as addition/deletion of workstations, renaming of the gateway, and viewing/control of connected source computers through interaction with the “agent software” as disclosed below. In sum, the source server module 214 serves to receive and route the data streams from the “gateway host” of a source computer 130 to the “gateway viewer” of a display computer 120.

The user administrator 216 is a tool provided for setting up system users and their corresponding permissions. Elaborate rules can be set for each user such as limitations on the user's ability to view and display content and their ability to create and execute system macros.

The user database 218 contains the permission sets for users of the system. It holds information pertaining to login and user action authentication. Communication with the user server module 212 is carried out through an implementation of the DCOM protocol. In sum, information about user login rights is stored in this database. Generally, only administrators are allowed to alter this file.

The control computer further comprises a plurality of drivers 215. Drivers are the interface between the software and the hardware ports. They also connect the interface manager 210 and the remote control agent as well as connecting the interface manager and the “display server agent” as disclosed below. It should be noted these drivers allow the overall system to control additional appliances and even to display additional sources from these appliances to the display wall 160. Such appliances include but are not limited to, a display cube, lights, a router, a VCR player, a DVD player, an audio player and the like. It should be noted these appliances are not integral parts of the control computer 110 and can be optionally deployed as required for a particular application.

Each of the display computers 120 directly controls its corresponding video wall 160. Each display computer comprises a plurality of software components or modules: 1) a display server agent 222, 2) a gateway host 224, 3) a gateway viewer 226 and 4) various local programs 228.

The “display server agent” 222 provides connectivity between the display computer 120 and the interface manager 210. Using DCOM, the interface manager 210 is able to connect through the local area network to the display computer 120 in order to manage it. The display computer can also house content programs 228 locally. These programs are then started through commands issued by the interface manager 210 and communicated to the display server agent 222. In addition to the ability to display data, the display computer 120 can also display digital video sources. Digital video sources include MPEG, Real, AVI, MOV, ASF video formats. If an internet connection is present, the display computer 120 can play streaming video sources from the web.

The “source or gateway viewer” 226 allows users to connect with source computers through the source server module 214. By establishing a connection with a source computer 130, users can view and control it.

The “source or gateway host” 224 serves to mirror the display information going to the video output card and sends it out the network port to the proxy gateway. It has features that filter and compress the data in order to reduce the bandwidth requirements on the network.

Each of the source computers 130 serves to provide a source of information that can be displayed on the video wall 160. Each source computer comprises a plurality of software components or modules: 1) a remote control agent 232, and 2) a gateway or source host 234.

The agent software is a client package that allows for the connection of the source server module 214 to a computer source through the use of two components, the “source host” 244 and the remote control agent 232. Having the source server module 214 establish a connection with the source host 234, the content of the source computer 130 can be viewed and displayed through the interface manager 210. Maintaining with the principle of flexible yet secure programs, the source host 234 allows users the option of password protecting their systems from unauthorized display by the interface manager 210.

The remote control agent 232 works closely with the source host component 234 and adds the functionality of source computer control. With this component, administrators can connect through the source server module 214 to the source computer 130 and take full control of it. This is especially useful for remotely connected content computers as applications can be started, files opened, and screen content can be dynamically changed.

Each of the remote control computers 140 serves to provide as an alternate computer to control the overall system. For example, a system supervisor can log into the system from home to control, verify or monitor the information that are currently being display on the video wall 160. Each remote control computer 140 comprises a plurality of software components or modules: 1) a remote manager 242, and 2) a gateway or source viewer 244.

The “remote manager” 242 grants users the same power and control as though they were sitting in front of the main interface manager 210. As long as the user is connected to the same local area network (i.e. be it through an internal local network connection, or through an external VPN or dial-up connection) as the main interface manager, the user will have the same authority over the system. Namely, the user has the ability to write and execute macros locally and on the main interface manager, to define wall layouts, to create virtual view screens, and to engage in live viewing and recording of computer source content. This component interacts with the centralized the user server module 212 to provide a dynamic level of restricted usage to various users.

Again, the source or gateway viewer 244 allows users to connect with source computers through the source server module 214. By establishing a connection with a source computer 130, users can view and control it.

The large scale display system 100 as a whole is capable of operating on a mixture of different communication protocols, e.g., Socket-level TCP/IP, Distributed Component Object Model (DCOM) and Serial RS-323 I/O Interface. Specifically, all network communication between source computers 130, the source server module 214, and display computers 120 are accomplished using TCP/IP sockets. This enables a high level of integration in client networks as TCP/IP is a de facto standard in both Microsoft Windows and UNIX environments. This low level protocol allows source computers 130 to be an assortment of different operating systems including Microsoft Windows and a variety of UNIX flavors.

Communication between various components of the overall system is also accomplished using the DCOM protocol. Having the system entirely Microsoft Windows based, has made the use of COM programming architecture desirable. The use of this architecture in the development of most of the system components has warranted the use of DCOM as the application communication protocol. Components that use this method to communicate include the interface manager 210 and its components excluding the source server module 214, user server module 212 and its components, and the display server software.

Connectivity of some external devices such as cameras and DVD players can be established with the interface manager 210 and the remote manager 242 through the use of standard serial I/O. Any device able to communicate using RS-323 can be programmed to interface with these two managers. It should be noted that although the above description discloses specific protocols and interfaces, the present invention is not so limited. Namely, those skilled in the art will realize that the present invention can be adapted to employ other types of protocols and interfaces.

The interface manager 210 serves as the control center of the entire display system. It empowers the user with the following features:

Activu Macro Language for creating system macros with abilities for execution.

ActivuPort for viewing and recording computer source and wall content.

Ability to define wall layout presets.

Ability to create virtual view screens.

The macro language found in the present system allows users to create code which can be tied to a single button. This programmed button can be used to recall presets (i.e. predefined wall layouts), open and operate both local and remote applications, control external devices (i.e. DVD Players, VCRs, cameras, etc.), power the walls on and off, etc. The control of external devices requires the use of a specifically written device driver. The macro interface also allows for the saving of created macro buttons and their associated layouts.

These layouts can be thought of as a user-configurable remote control for the overall large scale display system 100. “ActivuPort” is a feature that enables users of the interface manager 210 to connect to a source computer 130 or to a display computer 120 and to view in real-time the content which is currently being displayed. Also, an appropriate user can take control of this content. In addition to the viewing and controlling functions, ActivuPort also provides recording functions (i.e., recording of and playback of sessions). With the recording feature, entire screens and walls can be recorded to disk and are available for playback at future times. ActivuPort communicates with the source and display computers using a TCP/IP socket connection which allows for the viewing, controlling, and recording of not only Microsoft Windows machines but also several UNIX varieties.

Another feature is the ability to define and save a wall preset to a storage device, e.g., a disk. This gives the user the ability to quickly call up a preferred wall layout configuration at runtime. The layout can include anything which is displayed on the screen (i.e. local applications, videos, etc.)

View screen is a feature that allows users to create a maximum of 255 “virtual” walls per display. These walls and the layouts found on them are all stored in system RAM which allows for instant retrieval with their states being automatically updated at restore time. In other words, the user can easily swap between layouts without having to reconstruct a layout by populating the layout with sources from one or more source computers.

Security is provided to the overall system through the use of the user server module 212. All actions taken on the display system are first authenticated through the user server module 212. The user server module communicates using DCOM directly with all point-of-entry system components. Authentication information is found in a locally stored user database 218. All information pertaining to the different system users can be found here including usernames, passwords, and content placement and control permissions.

In turn, the user administrator 216 serves as a front end for administration. A system administrator can setup users, set passwords, and create permission rules for system users.

On the TCP/IP socket level, security is provided by each agent component. The source host 224 and 234 components of the Agent package can be password protected by the user to allow only authorized access to source computers.

The present system is capable of displaying not only data but video as well. In addition to the digital video capabilities of the system mentioned earlier, the present system is also capable of displaying any NTSC analog video source. The present display system has two methods of displaying video sources: “Windowed Video” and “Cubed Video”.

Windowed video is a method in which both digital and analog video sources can be displayed. Using this method, video is rendered on the display server agent 222 in a window and can be placed on the wall. This method of treating a video window as data allows for unrestricted control of the video's attributes including its size and placement on the wall. Unlike the cubed video method, windowed video has no restrictions to aspect ratios and can be sized and placed as pleased.

Cubed video is an analog video source which is directly displayed on the wall. The video source bypasses the display server agent 222 and input is directly switched by the interface manager 210 to the physical cube. The limitation of cubed video is that a static aspect ratio must be kept (i.e. video can only be played in whole cube sizes) and that only NTSC analog sources such as a DVD or a VCR can be displayed.

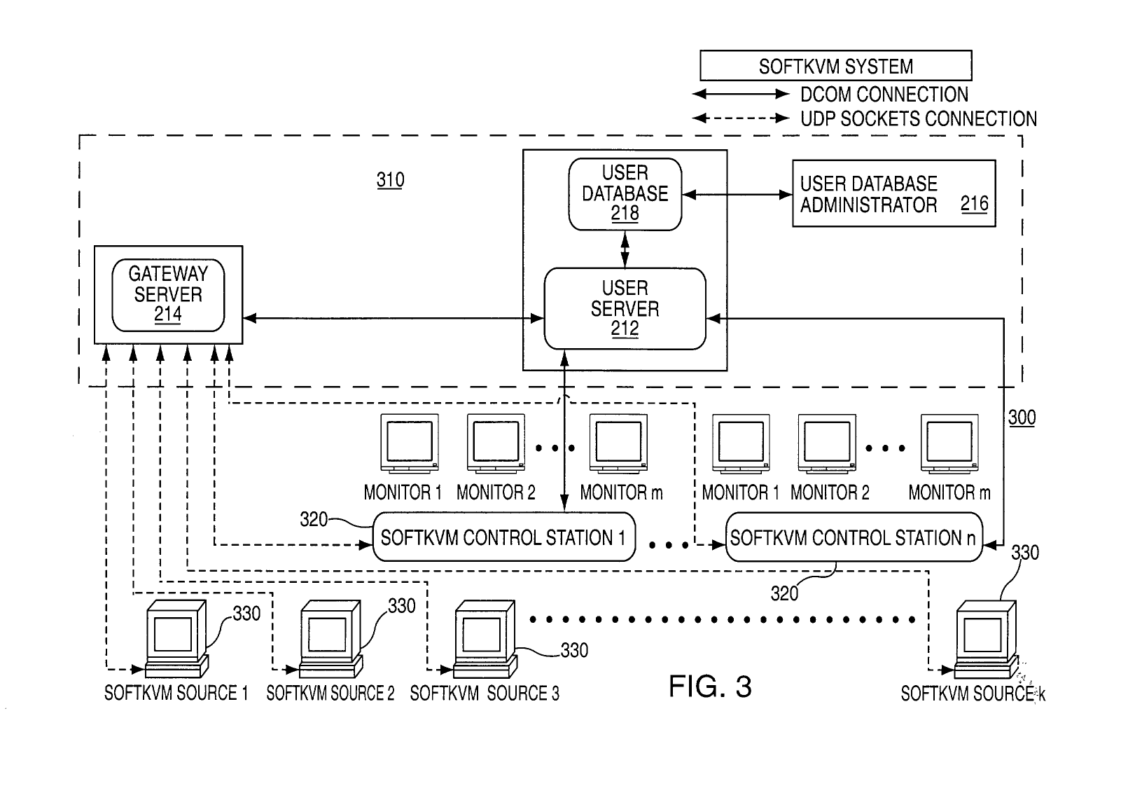

FIG. 3 illustrates a KVM (keyboard, monitor, mouse) system 300 of the present invention. This system shares similar components as disclosed above and as such some components share common reference numerals. The overall KVM system 300 comprises three distinct types of computing devices: a manager computer 310, one or more source computers 330, and one or more control workstations 320. The number of computing devices that are deployed in a system 300 depends on the need of a particular application.

The manager computer 310 is the communications heart of the KVM system. In one embodiment, it is a Microsoft Windows NT /2k/XP based server grade computer loaded with the key components, e.g., the user server module 212, the user database 218, and the user database administrator 216. A brief overview of these components is again provided below in the context of the present KVM system.

The user server module 212 is the center of the KVM system 300. All logins, session requests, and roaming user profiles are passed through the user server module 212. It provides authentication for all users of the KVM system through DCOM communication with the user database 218.

The user database 218 stores all information about the KVM system users including their user permissions and roaming profile information. Through the use of the user database administrator application 216, KVM system administrators can add/delete users and set their corresponding station permissions. Thus, the user database administrator 216 is an interface application that allows system administrators to interact with the user database 218.

The gateway or source server 214 provides connectivity of KVM source computers 330 with control workstations 320. This is accomplished through the gateway service that operates on this machine.

The gateway service provides connectivity of KVM source computers 330 with KVM control workstations 320. Through the use of a modified UDP communications stack, the gateway service can route multiple computer sources through itself to provide connectivity with authenticated KVM control stations 320. The gateway service is administrated through the use of the a “Network Source Administrator” that allows tasks such as addition/deletion of source workstations, renaming of the gateway, and viewing/control of connected source computers through interaction with the Agent Software.

In one embodiment, each KVM control workstation 320 is a Microsoft Win32 based workstation that KVM operators interact with directly to control their daily KVM needs. It is loaded with the KVM application in order to provide end users the ability to view and control KVM source computers.

The KVM control application is the front-end application used for interacting with the KVM system. The user interface is basically composed of two screens: a login screen used to authenticate with the user server module 212 and a user interaction bar that contains a list of available sources that the user can view or view/connect to. This application communicates with the gateway service through the use of a modified version of UDP protocol. Communication with the user server module 212 is through DCOM.

An KVM source computer 330 can be one of many platform computers that are currently available. The present KVM invention currently supports the following platforms as source computers: Microsoft Windows NT/2k/XP/95/98/ME, Sun Microsystems Solaris 2.5 and higher, HP-UX 10.00 and higher, IBM AIX 4.3.1 and higher, and the whole spectrum of modern Linux distributions.

The “Agent software” is again a client package that allows for the connection of the gateway service to a computer source. Having the gateway service establish a connection with the agent software, the visual output and control of the source computer can be routed to controllers using the KVM control manager software. Maintaining with the principle of flexible yet secure programs, the Agent software allows users the option of password protecting their systems from unauthorized display and control by the KVM control workstation 320.

The Agent also adds the functionality of source computer control. With this component, administrators can connect through the gateway service to the source computer and take full control of it. This is especially useful for remotely connected content computers as applications can be started, files opened, and screen content can be dynamically changed.

In one embodiment, the KVM system as a whole operates on a mixture of two different communication protocols: Modified UDP Protocol which incorporated error checking and Distributed Component Object Model (DCOM). All network communication between the source computers 330, the gateway service, and control workstations 320 are accomplished using a modified UDP protocol. The modification to the UDP protocol adds error checking ability. This enables a high level of integration in a client's network as UDP is a standard networking protocol in both Microsoft Windows and UNIX environments. This low level protocol allows source computers 330 to be an assortment of different operating systems including Microsoft Windows and a variety of UNIX flavors.

Communication between various components of the KVM system is accomplished using the DCOM protocol. Having the KVM entirely Microsoft Windows based, has made the use of COM programming architecture desirable. The use of this architecture in the development of most of the system components has warranted the use of DCOM as the application communication protocol. Components that use this method to communicate include the user server module 212, user database 218, user database administrator 216, and the KVM control workstations 320.

The present KVM system was designed to be a secure system. System security is controlled via the user server component of the system. The user server module 212 communicates with the user database 218 to authenticate system operators and is able to set roaming profiles for system users. This allows users the concept of virtual workstations meaning that a user can login to any station at their site and if authenticated, will have all their settings transferred to that station.

The following user specific permissions can be set in the user database:

User Login Passwords: Each operator can have his own password in order to protect his workstation and profile.

Control, Control/View Abilities (i.e. Read, Read/Write Abilities): This means that an operator's permissions can be set so he has only viewing privileges or that he has full (view/control) abilities of the KVM source.

Source Computer Access Control: Operator's permissions can be set so that they are only able to view, view/control only certain KVM source computers 330. The operator will only be allowed to bring up those source computers that are on his list.

Access Times: An operator's ability to login into his workstation can be restricted to specific times and dates. Additionally, his abilities to view, view/control KVM sources can also be restricted to a specific time and day.

The KVM system also provides source-level security through the Agent component which runs on a source computer 330. If for any reason, a user does not wish to have his computer as part of the KVM system, he can easily block view and/or view/control requests. This feature can also be set on the clock so that all KVM view, view/control requests are blocked automatically at a specific time or on specific days.

In operation, a user sits at an KVM control workstation 320. The user inputs his username and password combination and the request is sent to the user server module 212. The user server module communicates with the user database 218 and the user database returns the profile information associated to the user server module. The user server module now retains all information pertaining to the user. If authentication succeeds, then the user is granted access to the KVM system and his desktop is constructed from his profile.

In turn, the user requests a view/control session a source computer #1 330. The request is first sent to the user server module for authentication. When this process is completed successfully, the user server sends this authentication through to the gateway server. The gateway server then routes this request to the desired source computer 330. The request then is passed to the Agent application running on the source computer 330 for authentication. If the source computer 330 is accepting connections, then the request will complete successfully and the user at the KVM Control Workstation gains viewing and controlling abilities for the source computer 330. All traffic then operates through the gateway server which provides the ability to route multiple connections of the same source computers 330.

Namely, the above KVM system avoids the need for and expense of physical KVM (keyboard, video, mouse) switching, and being entirely network based, it also avoids the need for additional wiring. This “soft” KVM approach also enables more sophisticated control access rules to be programmed.

First, the soft KVM leverages off the same control manager/gateway as disclosed in the large scale display system 100 and has very similar architecture to the wall display sub-system. Each user workstation in effect becomes a display computer, driving any number of screens via single or multi-graphics cards. The present soft KVM operates as a floating toolbar positioned on any one of the screens with a pull-down list of sources. Each selected source displays exactly across one operator screen.

Any source can be expanded to display across multiple screens if required, and any source exceeding the screen resolution (even including a whole data wall) can be displayed in compressed form or 1:1, with scroll bar control. Multiple sources can be windowed or toiled on the same screen.

Application control can be taken by a user and any screen cleared, via a pull-down menu. Simplified wall control can be added, e.g., to place an application at a pre-selected position on a data wall or other large display.

Multiple operating systems can be simultaneously displayed and controlled with a single mouse and keyboard, as the mouse moves from screen to screen it automatically changes identity, e.g. Linux to NT to Solaris.

Unlike conventional KVM switching, there is no matrix switching and no additional wiring. The present “soft” KVM system only requires a small software application running on the servers, the user workstations and a separate Control Manager/Gateway server connected to the LAN. There is also no limit as to source resolution.

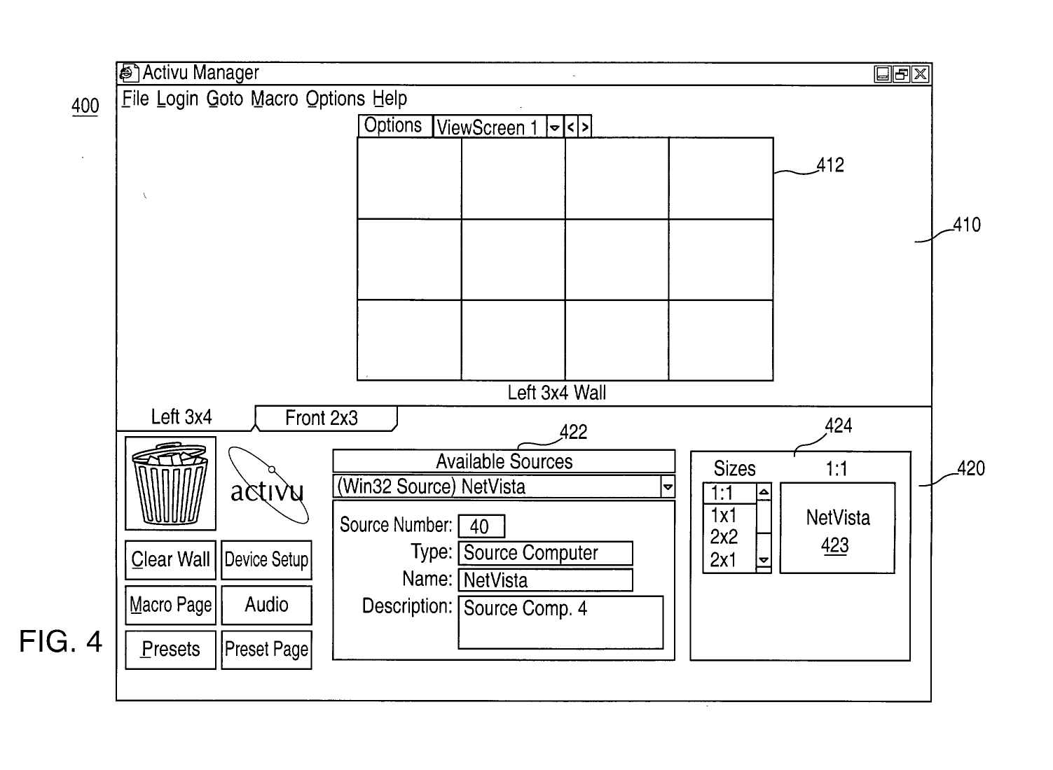

FIG. 4 illustrates a first screen display 400 as viewed by an operator of the large scale display system of the present invention. Namely, the display illustrates an efficient and user friendly GUI interface. The screen is divided into a upper portion 410 and a lower portion 420.

The upper portion 410 provides for a symbolic view or icon 412 of the video wall and optionally, the associated number of display units that form the entire video wall. The lower portion provides a plurality of sections or fields that relate to the available sources that can be dragged and dropped onto the video wall for display. Specifically, field 422 provides a listing of available sources in terms of source number, source type, name and description. Field 424 provides the available sizes of the source, i.e., selecting a different size on the menu bar will cause the icon 423 next to the size selection menu bar to change in size for drag and drop operation.

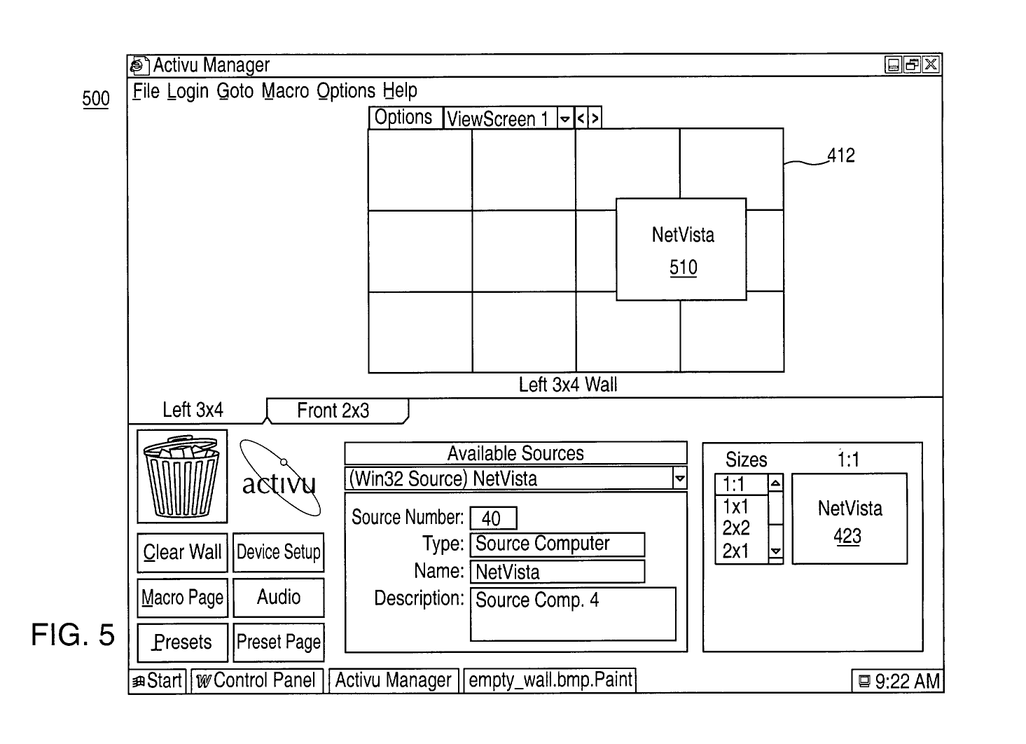

FIG. 5 illustrates a second screen display as viewed by an operator of the large scale display system of the present invention. Specifically, FIG. 5 illustrates an icon 510 representative of a source 423 that was dragged and dropped onto the symbolic video wall icon 412. The placement and size of dropped source within the video wall icon 412 correlates to the placement and size of the source as it is ultimately displayed on the physical video wall 160. This efficient user interface allows an operator to compose and save numerous layouts of varying sources that can be displayed on the video wall 160.

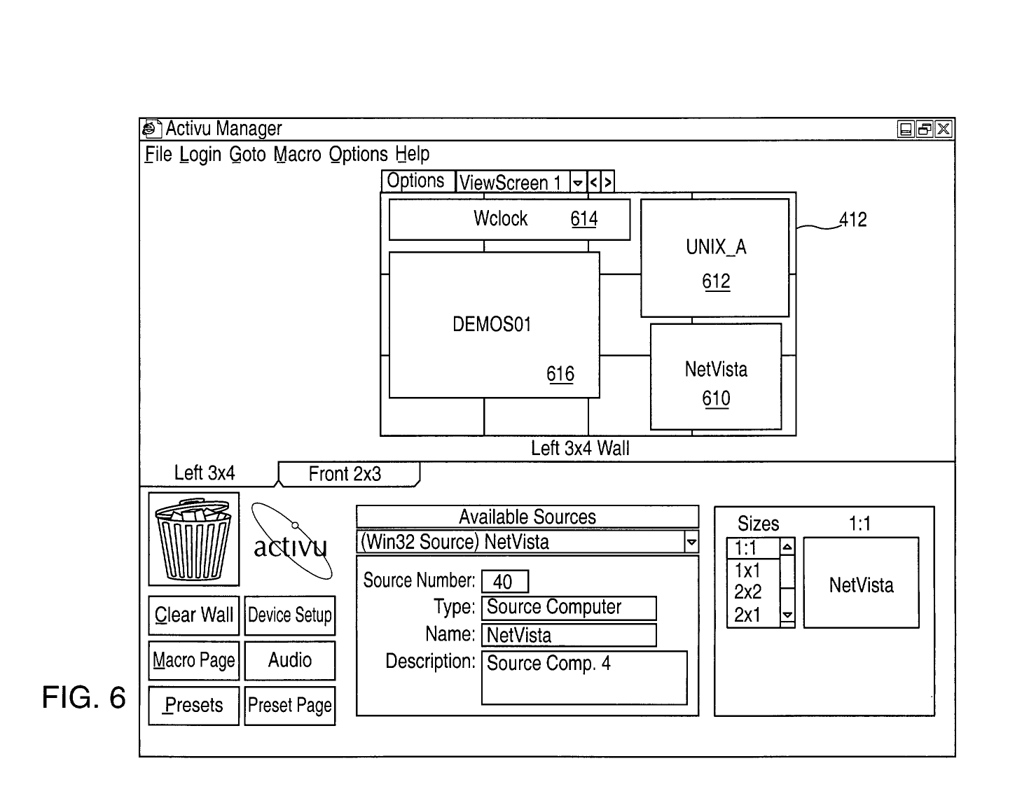

FIG. 6 illustrates a third screen display as viewed by an operator of the large scale display system of the present invention. Specifically, FIG. 6 illustrates the symbolic video wall icon 412 having a display layout composed of a plurality of sources 610-616. The layout is currently being referred to as “ViewScreen 1”.

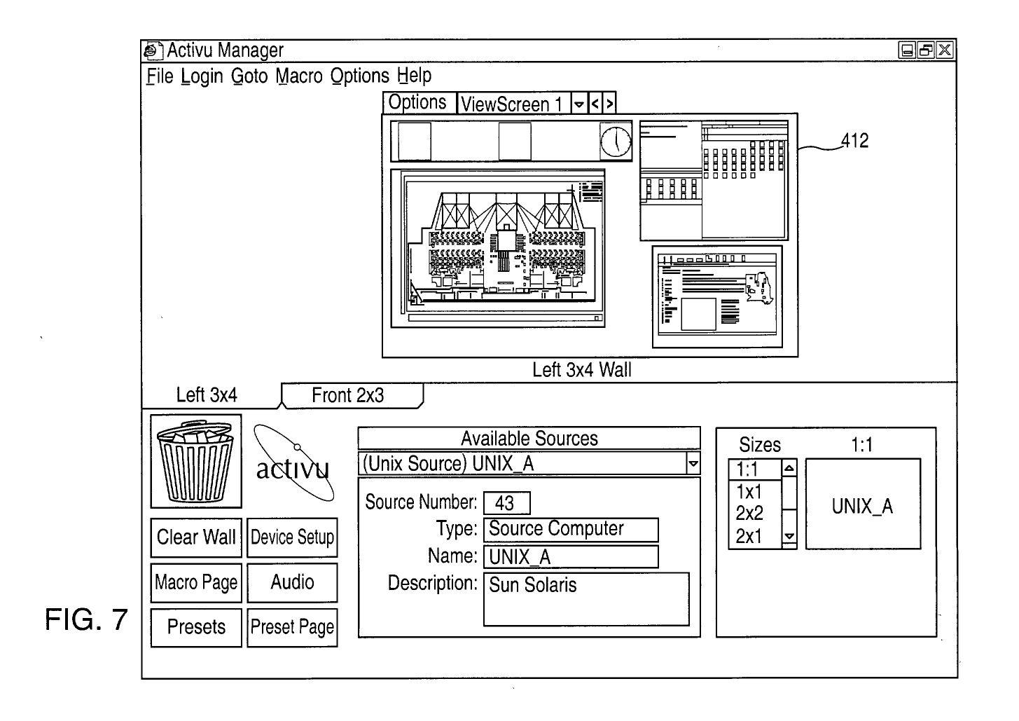

FIG. 7 illustrates a fourth screen display as viewed by an operator of the large scale display system of the present invention. Specifically, FIG. 7 illustrates the symbolic video wall icon 412 having a display layout composed of a plurality of sources 610-616 that are actually being displayed. Thus, an operator can remotely compose, display, and monitor a plurality of sources that are displayed on a remote video wall. In fact, as discussed above, through the use of device drivers, it is even possible to control the lighting of a room and audio volume control in which the video wall is located.

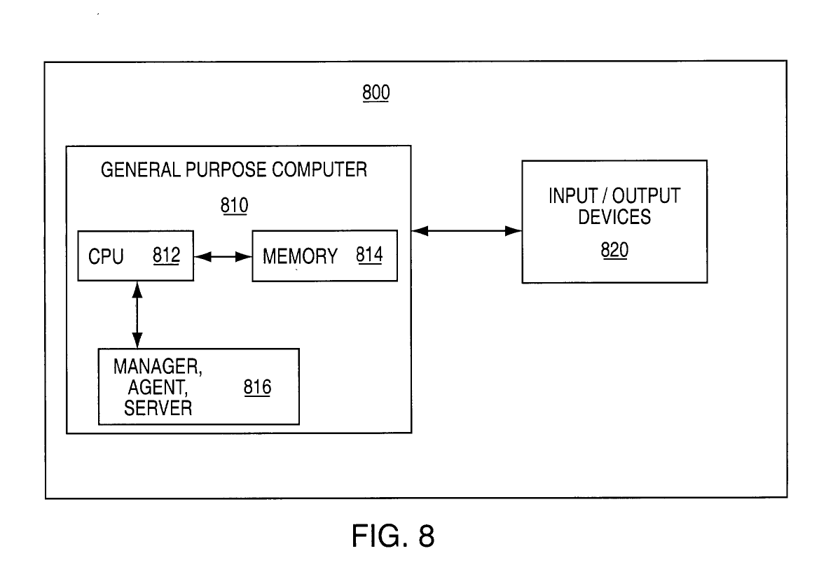

FIG. 8 illustrates a block diagram of a computing device 800 from the large scale display system of the present invention as implemented using a general purpose computer. Namely, computing device 800 can be a control computer, a display computer, a source computer, a remote control computer, a manager computer or a control workstation as disclosed above.

The computing device comprises a processor (CPU) 812, a memory 814, e.g., random access memory (RAM) and/or read only memory (ROM), one or more manager, agent, and/or server modules 816, and various input/output devices 820, (e.g., storage devices, including but not limited to, a tape drive, a floppy drive, a hard disk drive or a compact disk drive, a receiver, a transmitter, a speaker, a display, a speech signal input device, e.g., a microphone, a keyboard, a keypad, a mouse, an A/D converter, and the like).

Namely, the manager, agent, and/or server modules 816 can be any of the above disclosed software components. It should be understood that the manager, agent, and/or server modules 816 can be implemented as one or more physical devices that are coupled to the CPU 212 through a communication channel. Alternatively, the manager, agent, and/or server modules 816 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 814 of the computer. As such, the manager, agent, and/or server modules 816 (including associated methods and data structures) of the present invention can be stored on a computer readable medium, e.g., RAM memory, magnetic or optical drive or diskette and the like.

Although various embodiments which incorporate the teachings of the present invention have been shown and described in detail herein, those skilled in the art can readily devise many other varied embodiments that still incorporate these teachings.

What is claimed is:

1. A display system comprising:
a control computer having a source server module, an interface manager and a user server module;
a display computer having a display server agent and a gateway host for communicating with said control computer; and
a video wall, coupled to said display computer.

2. The display system of claim 1, further comprising:
a source computer having a remote control agent and a gateway host for communicating with said control computer, wherein said source computer further having at least one data source that is accessible by said interface manager to be displayed on said video wall.

3. The display system of claim 1, further comprising:
a remote control computer having a remote manager and a gateway viewer for communicating with said control computer for accessing said interface manager of said control computer.

4. A display system comprising:
a manager computer having a source server module and a user server module;
a control station for communicating with said manager computer, said control station having a plurality of displays; and
a source computer for communicating with said manager computer, wherein said source computer having at least one data source that is accessible by said source server module to be displayed on at least one of said displays of said control station.

5. A method for displaying a data source on a large scale display, said method comprising the steps of:
a) composing a layout on a local control computer, wherein said layout contains at least one data source that is located remotely from said local control computer;
b) accessing said at least one data source from a source computer; and
c) causing said at least one data source to be displayed on said large scale display, wherein said large scale display is located remotely from said local control computer.
